(19) United States
(12) Patent Application Publication
(10) Pub. No.: US 2013/0284327 A1
(43) Pub. Date: Oct. 31, 2013

(54) COPPER ALLOY FOR ELECTRONIC DEVICE, METHOD OF PRODUCING COPPER ALLOY FOR ELECTRONIC DEVICE, AND COPPER ALLOY ROLLED MATERIAL FOR ELECTRONIC DEVICE

(71) Applicants: Kazunari Maki, Saitama-shi (JP); Yuki Ito, Okegawa-shi (JP)

(72) Inventors: Kazunari Maki, Saitama-shi (JP); Yuki Ito, Okegawa-shi (JP)

(73) Assignee: MITSUBISHI MATERIALS CORPORATION, Tokyo (JP)

(21) Appl. No.: 13/990,939

(22) PCT Filed: Nov. 24, 2011
(86) PCT No.: PCT/JP2011/077011

§ 371 Date: Jul. 19, 2013

(30) Foreign Application Priority Data
Dec. 3, 2010 (JP) 2010-270890

(51) Int. Cl. H01B 1/02; H01B 13/00

(52) U.S. Cl. CPC H01B 1/026; H01B 13/0016
USPC 148/684; 148/436; 148/434; 148/435; 148/433

(57) ABSTRACT

A copper alloy for an electric device contains Mg in a range of 1.3 atomic % or more and less than 2.6 atomic %, Al in a range of 6.7 atomic % or more and 20 atomic % or less, and the balance substantially consisting of Cu and unavoidable impurities. A method of producing a copper alloy includes: performing heating of a copper material to a temperature of not lower than 500° C. and not higher than 1000° C.; performing quenching to cool the heated copper material to 200° C. or lower with a cooling rate of 200° C./min or more; and performing working of the cooled copper material, wherein the copper material is composed of a copper alloy containing Mg in a range of 1.3 atomic % or more and less than 2.6 atomic %, Al in a range of 6.7 atomic % or more and 20 atomic % or less.

### FIELD OF THE INVENTION

The present invention relates to a copper alloy for an electronic device, a method of producing a copper alloy for an electronic device, and a copper alloy rolled material for an electronic device that are applicable to electronic and/or electric components such as, for example, terminals, connectors, and relays.

Priority is claimed on Japanese Patent Application No. 2010-270890 filed on Dec. 3, 2010, the content of which is incorporated herein by references.

### BACKGROUND ART

Conventionally, in accordance with a reduction of the sizes of electronic devices and electric devices, there have been efforts to reduce the size and the thickness of electronic/electric components such as terminals, connectors, and relays used in these electronic devices and electric devices.

Therefore, a copper alloy having excellent springness, strength, and electrical conductivity is required as a material for constituting the electronic/electric device. Specifically, as described in Non Patent Reference 1, one having high yield strength and low Young's modulus is desirable as a copper alloy used in the form of electronic/electric device such as terminals, connectors, and relays.

Therefore, as an example of a copper alloy having excellent springiness, strength, and electric conductivity, Patent Reference 1 provides a Cu—Be alloy that contains Be. In Patent Reference 1, strength of the alloy is improved without reducing electrical conductivity by aging precipitation of CuBe in the matrix of the alloy. Therefore, this Cu—Be alloy is a precipitation hardening type high strength alloy.

However, raw material cost of the Cu—Be alloy is very high since the alloy contains expensive element, Be. In addition, toxic Be oxide is generated during the production of the Cu—Be alloy. Therefore, a production appliance must have a specific constitution so as to prevent accidental leakage of Be oxide to the outer environment during the production process and the Be oxide must be strictly controlled

As explained above, there has been problems that both of the raw material cost and production cost were very high for the Cu—Be alloy. In addition, from the view point of environmental measure, the alloy has been unwanted due to inclusion of Be which is a toxic element as described above.

Therefore, there has been strong demand for material that can replace Cu—Be alloy.

For example, Patent Reference 2 provides a Cu—Ni—Si based alloy (so called Corson alloy) as a material that can replace the Cu—Be alloy. The Corson alloy is a precipitation hardening type alloy that includes dispersed Ni₂Si precipitates and has a relatively high electrical conductivity, strength, and strain relaxation property. Therefore, the Corson alloy is frequently used in applications such as terminals for automobiles and small terminals for signal system, and is developed actively in the recent years.

Cu—Mg—P alloy described in Patent Reference 3 is developed as another alternative alloy.

However, the Corson Alloy disclosed in Patent Reference 2 generally has a relatively high Young's modulus of 125 to 135 GPa. In the type of connectors having a constitution in which male tab is inserted to the female adapter while pushing up the spring contact section, contact pressure changes drastically at the time of insertion where the material for forming the connector has high Young's modulus. In addition, there is a possibility of easily exceeding the elasticity limit and resulting in plastic deformation. Therefore, a material of high Young's modulus is not preferred for the above-described connector.

In the Cu—Mg—P alloy described in Patent Reference 3, the electrical conductivity was high, but mechanical properties such as yield strength and tensile strength were insufficient. In addition, there has been a problem in that the alloy was not applicable to connectors or the like due to a relatively high Young's modulus.

### PRIOR ART REFERENCE

### Patent Reference

Patent Reference 1: Japanese Unexamined Patent Application, First Publication No. H04-268033.
Patent Reference 2: Japanese Unexamined Patent Application, First Publication No. H11-036055.
Patent Reference 3: Japanese Unexamined Patent Application, First Publication No. S62-227051.

### Non Patent Reference

Non Patent Reference 1: Moya NOMURA, “Technological Trend of High Performance Copper Alloy Strips for Connectors and Development Strategy in Our Company”, Kobe Steel engineering reports, Vol. 54, No. 1 (2004), p. 2-8.

### SUMMARY OF THE INVENTION

### Problems to be Solved by the Invention

Based on a consideration of the above-described circumstance, an object of the present invention is to provide a copper alloy for an electronic device having a low Young's modulus, a high yield strength, and high electrical conductivity, and being appropriate for application in electric/electronic components such as terminals, connectors, and relays, and to provide a method of producing the copper alloy for an electronic device, and copper alloy rolled material for an electronic device.

### Solution of the Problems

Aspects of the present invention are described below.

[1] A copper alloy for an electric device containing Mg in a range of 1.3 atomic % or more and less than 2.6 atomic %, Al in a range of 6.7 atomic % or more and 20 atomic % or less, and the balance substantially consisting of Cu and unavoidable impurities.
[2] The copper alloy for an electronic device according to the above-described [1], further containing one or more selected from Zn, Sn, Si, Mn, and Ni in an amount of 0.05% atomic % or more and 5 atomic % or less.
[3] The copper alloy for an electronic device according to the above-described [1] or [2], further containing one or more selected from B, P, Zr, Fe, Co, Cr, Ag, Ca, and rare earth elements in an amount of 0.01% atomic % or more and 1 atomic % or less.
[4] The copper alloy for an electronic device according to any one of the above-described [1] to [3], wherein yield strength at 0.2% (σ_{0.2}) is 400 MPa or more.
[5] The copper alloy for an electronic device according to any one of the above-described [1] to [5], wherein Young's modulus E is 125 GPa or less.
[6] The copper alloy for an electronic device according to any one of the above-described [1] to [5], wherein average number of intermetallic compounds having a particle diameter of 0.1 μm or more is 10 μm² or less under the observation using a scanning electron microscope.
[7] A method of producing a copper alloy for an electronic device according to any one of the above-described [1] to [6], including: performing heating of a copper material to a temperature of not lower than 500° C. and not higher than 1000° C., performing quenching (rapid-cooling) to cool the heated copper material to 200° C. or lower with a cooling rate of 200° C./min or more; and performing working (processing) of the cooled copper material, wherein the copper material is composed of a copper alloy containing Mg in a range of 1.3 atomic % or more and less than 2.6 atomic %, Al in a range of 6.7 atomic % or more and 20 atomic % or less, and the balance being substantially consisting of Cu and unavoidable impurities.
[8] The method of producing a copper alloy for an electronic device according to the above-described [7], wherein the copper alloy that composes the copper material further contains one or more selected from Zn, Sn, Si, Mn, and Ni in an amount of 0.05% atomic % or more and 5 atomic % or less.
[9] The method of producing a copper alloy for an electronic device according to the above-described [7] or [8], wherein the copper alloy that composes the copper material further contains one or more selected from B, P, Zr, Fe, Co, Cr, Ag, Ca, and rare earth elements in an amount of 0.01% atomic % or more and 1 atomic % or less.
[10] A copper alloy rolled material (rolled copper alloy) for an electronic device, comprising the copper alloy for an electronic device according to any one of the above-described [1] to [6], wherein Young's modulus E in the rolling direction is 125 GPa or less and a yield strength σ_{0.2} at 0.2% in the rolling direction is 400 MPa or more.
[11] The copper alloy rolled material for an electronic device according to the above-described [10] that is used as terminals, connectors, or relays.

An aspect of a copper alloy for an electric device according to the present invention contains Mg in a range of 1.3 atomic % or more and less than 2.6 atomic %, Al in a range of 6.7 atomic % or more and 20 atomic % or less, and the balance substantially consisting of Cu and unavoidable impurities.

This copper alloy for an electronic device is constituted as a copper alloy that contains Mg, Al, with the balance substantially consisting of Cu and unavoidable impurities, where the content of Mg and the content of Al are regulated as described-above. The copper alloy having this component composition has properties of low Young's modulus and high strength, and relatively high electrical conductivity.

Preferably, the above-described copper alloy for electronic device further contains one or more selected from Zn, Sn, Si, Mn, and Ni in an amount of 0.05% atomic % or more and 5 atomic % or less.

By adding one or more element selected from Zn, Sn, Si, Mn, and Ni to the above-described copper alloy for an electronic device, it is possible to further improve the properties of copper alloy. Therefore, it is possible to provide a copper alloy that is suitable for an intended use by selective addition of the above-described elements in accordance with the intended use of the copper alloy.

Preferably, the above-described copper alloy for an electronic device further contains one or more selected from B, P, Zr, Fe, Co, Cr, Ag, Ca, and rare earth elements in an amount of 0.01% atomic % or more and 1 atomic % or less.

It is possible to improve the properties of copper alloy by adding one or more element selected from B, P, Zr, Fe, Co, Cr, Ag, Ca, and rare earth elements to the above described copper alloy for an electronic device. Therefore, it is possible to provide a copper alloy that is suitable for an intended use by elective addition of the above-described elements in accordance with the intended use of the copper alloy.

Preferably, the above-described copper alloy for an electronic device has yield strength at 0.2% (σ_{0.2}) of 400 MPa or more.

Preferably, the above-described copper alloy for an electronic device has a Young's modulus E of 125 GPa or less.

Where the yield strength σ_{0.2} at 0.2% is 400 MPa or more or the Young's modulus E is 125 GPa or less, the alloy has a high elastic energy coefficient (σ_{0.2}²/2E) and is not plastically deformed easily. Therefore, the copper alloy for electronic device is specifically applicable to electronic/electric components such as terminals, connectors, relays or the like.

Preferably, in the above-described copper alloy for electronic device, average number of intermetallic compounds having a particle diameter of 0.1 μm or more is 10/μm² or less under the observation using a scanning electron microscope.

In this case, since the average number of intermetallic compounds having a particle diameter of 0.1 μm or more under the observation using a scanning electron microscope is controlled to be 10/μm² or less, precipitation of coarse intermetallic compound is suppressed and at least partial fractions of Mg and Al are dissolved in the matrix phase. It is possible to increase the strength and recrystallization temperature while maintaining high electrical conductivity and to reduce the Young's modulus by thus dissolving at least partial fractions of Mg and Al in the matrix phase.

The average number of intermetallic compounds having a particle diameter of 0.1 μm or more is calculated based on observation of 10 visual fields each having an area of 4.8 μm² at 50000 fold magnification using a field emission type scanning electron microscope.

The diameter of each particle of the intermetallic compound is achieved as an average value of the length of major axis and the length of minor axis of the intermetallic compound. The length of major axis denotes a length of the longest straight line that can be drawn in the particle without having contact with a grain boundary in the intermediate position, and the length of minor axis denotes the length of the longest straight line that can be drawn in the particle along the direction perpendicular to the major axis without having contact with a grain boundary in the intermediate position.

An aspect of a method of producing a copper alloy for an electronic device according to the present invention is a method of producing the above-described aspect of a copper alloy for an electronic device.

An aspect of a method of producing a copper alloy for an electronic device includes: performing heating of a copper material to a temperature of not lower than 500° C. and not higher than 1000° C., performing quenching to cool the heated copper material to 200° C. or lower with a cooling rate of 200° C./min or more; and performing working of the cooled copper material, wherein the copper material is composed of a copper alloy containing Mg in a range of 1.3 atomic % or more and less than 2.6 atomic %, Al in a range of 6.7 atomic % or more and 20 atomic % or less, and the balance being substantially consisting of Cu and unavoidable impurities.

According to the above-described method of producing copper alloy for an electronic device, it is possible to dissolve (solid-solubilize) the Mg and Al by the heating to heat the copper material containing Mg and Al in the above-described composition to the temperature of not lower than 500° C. and not higher than 1000° C. Here, if the heating temperature is lower than 500° C., there is a possibility that the dissolution is insufficient, and large amount of intermetallic compound remains in the matrix. On the other hand, if the heating temperature exceeds 1000° C., there is a possibility that the copper material is partially molten to form liquid phase, resulting in inhomogeneous microstructure and surface state. Therefore, the heating temperature is controlled to be in a range of not lower than 500° C. and not higher than 1000° C.

In addition, since the method includes quenching to cool the heated copper material to 200° C. or lower with a cooling rate of 200° C./min or more, it is possible to suppress precipitation of coarse intermetallic compounds during the cooling process. Therefore it is possible to dissolve (solid-solubilize) at least partial fractions of Mg and Al in the matrix phase.

Further, since the method includes working to work the quenched copper material, it is possible to improve the strength of the alloy by work-hardening. The method of working is not particularly limited. For example, rolling is applied where the final shape is a plate or a bar. Wire-drawing or extrusion is applied where the final shape is wire or a rod. Forging or pressing is applied, where the final shape is bulky shape.

Working temperature is not particularly limited. In order to prevent the occurrence of precipitation, it is preferable to use a temperature in a range of −200 to 200° C. such that the working is performed in cold or warm working conditions. The working ratio (reduction ratio) is selected arbitrarily such that the alloy is given a shape close to the final shape by the working. Based on the consideration of work hardening, it is preferable to control the working ratio to be 20% or more, and preferably 30% or more.

Here, the working ratio denotes a value that is a percentage expression of a ratio that is calculated by dividing a difference between the cross sectional area of a material before working and the cross sectional area of the material after the working by the cross sectional area of the material before the working.

So called low temperature annealing may be performed after the working. It is possible to further improve the mechanical properties of the alloy using the low temperature annealing.

In the above-described method of producing copper alloy for electronic device, the copper alloy that composes the copper material may further contain one or more selected from Zn, Sn, Si, Mn, and Ni in an amount of 0.05% atomic % or more and 5 atomic % or less.

The copper alloy that composes the copper material may further contain one or more selected from B, P, Zr, Fe, Co, Cr, Ag, Ca, and rare earth elements in an amount of 0.01% atomic % or more and 1 atomic % or less.

It is possible to improve the properties of the produced copper alloy for an electronic device by using a copper material containing the above-described elements.

An aspect of a copper alloy rolled material for an electronic device according to the present invention includes the above-described copper alloy for an electronic device, wherein Young's modulus E in the rolling direction is 125 GPa or less and a yield strength σ_{0.2} at 0.2% in the rolling direction is 400 MPa.

The copper alloy rolled material for an electronic device according to the above-described aspect has a high elastic energy coefficient (σ_{0.2}²/2E), and does not easily cause plastic deformation.

The above-described aspect of the copper alloy rolled material for an electronic device is preferably used as a copper raw material for constituting terminals, connectors, or relays.

### Effect of the Invention

According to the aspects of the present invention, it is possible to provide a copper alloy for an electronic device that has a low Young's modulus, a high yield strength, and high electrical conductivity, and that is appropriately used in electronic and/or electric components such as terminals, connectors, and relays, and to provide a method for producing a copper alloy for an electronic device, and a copper alloy rolled material for an electronic device.

### BRIEF EXPLANATION OF DRAWINGS

FIG. 1 is a flow diagram of a method of producing copper alloy for an electronic device according to an embodiment of the present invention.

FIG. 2 shows photographs taken by scanning electron microscopy in Example 12.

### MODE FOR CARRYING OUT THE INVENTION

The following description provides explanation for copper alloy for an electronic device according to an embodiment of the present invention.

A copper alloy for an electronic device of the present invention has a composition containing Mg in a range of 1.3 atomic % or more and less than 2.6 atomic %, Al in a range of 6.7 atomic % or more and 20 atomic % or less, and further containing one or more selected from Zn, Sn, Si, Mn, and Ni in a range of 0.05 atomic % or more and 5 atomic % or less, and one or more selected from B, P, Zr, Fe, Co, Cr, Ag, Ca, and rare earth elements in a range of 0.01 atomic % or more and 1 atomic % or less, and the balance consisting of Cu and unavoidable impurities.

Under the observation of the copper alloy for an electronic device of the present embodiment using a scanning electron microscope, an average number of intermetallic compounds of particle diameter of 0.1 μm or more is 10/μm² or less.

The reason for controlling these elements in the above-described range will be explained in the following.

### Mg

Mg is an element that has effects of improving the strength of the alloy and increasing the recrystallization temperature while avoiding a large reduction of electrical conductivity. In addition, it is possible to suppress the Young's modulus to a low value by dissolving Mg in the matrix phase.

Where the content of Mg is less than 1.3 atomic %, it is impossible to achieve its effects.

On the other hand, where the content of Mg is 2.6 atomic % or more, liquid phase may partially occur resulting in cracking when a hot rolling of the alloy is performed while controlling material temperature to be 800° C. or higher. Therefore, it is impossible to use high material temperature during the hot rolling, resulting in reduction of productivity.

Based on the above explained reason, content of Mg is controlled to be 1.3 atomic % or more and less than 2.6 atomic %.

### Al

Al is an element that has an effect of largely improving the strength of the alloy while avoiding an increase of the Young's modulus by being dissolved in the copper alloy dissolving partial or total fraction of Mg.

Where the amount of Al is less than 6.7 atomic %, it is impossible to achieve the above effect. On the other hand, where the amount of Al exceeds 20 atomic %, a large amount of intermetallic compound remains in the time of performing heat treatment for forming a solid-solution, possibly causing cracks during the subsequent process such as working.

For the above-described reason, the amount of Al is controlled to be in a range of 6.7 atomic % or more and 20 atomic % or less.

### Zn, Sn, Si, Mn, Ni

The elements such as Zn, Sn, Si, Mn, Ni have effects of improving the properties of a copper alloy by being added to the copper alloy dissolving partial or total fractions of Mg and Al. Therefore, it is possible to improve the properties of the alloy by selective addition in accordance with the intended use. Specifically, Zn has an effect of improving the strength of the alloy without reducing the electrical conductivity.

Where the content of the elements such as Zn, Sn, Si, Mn, and Ni is less than 0.05 atomic %, it is impossible to achieve the effects of these elements. On the other hand, where content of the one or more elements selected from Zn, Sn, Si, Mn, and Ni exceeds 5 atomic %, electrical conductivity of the alloy is reduced largely. In addition, a large amount of coarse intermetallic compound remains in the time of performing heat treatment for forming a solid-solution, possibly causing cracks or the like during the subsequent process such as working.

Based on the above-described reason, the amount of the elements such as Zn, Sn, Si, Mn, and Ni is controlled to be 0.05 atomic % or more and 5 atomic % or less.

Where two or more of the above-described element is contained in the alloy, the above-described amount denotes total amount of the elements.

B, P, Zr, Fe, Co, Cr, Ag, Ca, rare earth elements

Elements such as B, P, Zr, Fe, Co, Cr, and Ag have effects of improving properties of a copper alloy by being added to the copper alloy in which Mg and Al are partially or totally dissolved. Therefore, it is possible to improve the property of the alloy by selective addition in accordance with the intended use.

In the rare earth elements, one or more elements may be selected from Sc, Y, La, Ce, Pr, Nd, Pm, Sm, Eu, Gd, Tb, Dy, Ho, Er, Tm, Yb, and Lu.

Where the content of the one or more elements selected from B, P, Zr, Fe, Co, Cr, Ag, Ca, and rare earth elements is less than 0.01 atomic %, it is impossible to achieve their effects. On the other hand, where the content of the one or more elements selected from B, P, Zr, Fe, Co, Cr, Ag, Ca and rare earth elements exceeds 1 atomic %, the electrical conductivity is largely reduced. In addition, there is a possibility that large amount of coarse compounds remains in the time of heat treatment for forming a solid-solution.

For the above-described reason, the amount of elements such as B, P, Zr, Fe, Co, Cr, Ag, Ca, and rare earth elements is controlled to be 0.01 atomic % or more and 1 atomic % or less.

Where two or more of the above-described element is contained in the alloy, the above-described amount denotes total amount of the elements.

The unavoidable impurities may include Sr, Ba, Hf, V, Nb, Ta, Mo, W, Re, Ru, Os, Se, Te, Rh, Ir, Pd, Pt, Au, Cd, Ga, In, Li, Ge, As, Sb, Ti, Tl, Pb, Bi, S, O, C, Be, N, H, Hg or the like. Preferably, the total amount of these unavoidable impurities is controlled to be 0.3% by mass or less.

Microstructure (texture)

The result of observation of copper alloy for an electronic device of the present embodiment using a scanning electron microscope shows that average numbers of intermetallic compounds having a particle diameter of 0.1 μm or more is 10 μm² or less. That is, coarse intermetallic compounds are not precipitated in large number, and at least partial fractions of Mg and Al are dissolved in the matrix phase.

Where the solution treatment is incomplete, or large sized intermetallic compounds exist in a large amount due to precipitation of the intermetallic compounds after the solution treatment, these intermetallic compounds may function as starting points of cracking. As a result, cracks are generated during the working, and bendability is deteriorated largely. In addition, a large amount of intermetallic compounds increases the Young's modulus of the alloy. Therefore, such a microstructure is not preferred

The result of examination of the microstructure shows that satisfactory bendability and a low Young's modulus can be obtained where the numbers of intermetallic compounds having a particle diameter of 0.1 μm or more is 10 μm² or less in the alloy, that is, where the coarse intermetallic compounds are absent or exist in a small amount.

In order to achieve the above described effect securely, it is preferable to control the numbers of intermetallic compound having a particle diameter of 0.1 μm or more is controlled to be 1/μm² or less in the alloy. More preferably, the numbers of intermetallic compound having a particle diameter of 0.05 μm or more is controlled to be 1/μm² or less in the alloy where the bendability is strongly required.

In the determination of the average number of the intermetallic compounds, ten visual fields each having an area of 4.8 μm² were observed at 50000 times magnification using a field emission type scanning electron microscope, and the average of the numbers of the intermetallic compounds is calculated.

The particle diameter of each intermetallic compound is achieved as an average value of the length of major axis and the length of minor axis. The length of the major axis denotes the length of the longest straight line that can be drawn in the particle without having contact with a grain boundary in the intermediate position. The length of minor axis denotes the length of the longest straight line that can be drawn in the particle along the direction perpendicular to the major axis without having contact with a grain boundary in the intermediate position.

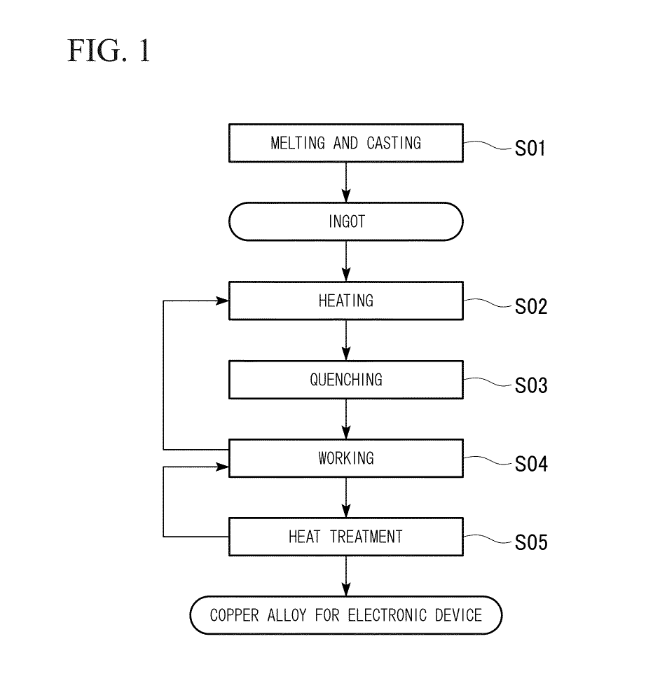

Next, a method of producing a copper alloy for an electronic device of the present embodiment having the above-described constitution is explained with reference to the flow diagram shown in FIG. 1.

### Melting and Casting Step: S01

Firstly, the above-described elements are added to a copper melt formed by melting of copper raw material, and the composition of the melt is controlled to form a melt of copper alloy. The elements such as Mg and Al may be added by using simple substances of Mg, Al, or the like, or by using precursor alloy. On the other hand, raw material (raw materials) including the above-described elements and the copper raw material may be molten simultaneously. The melt may also be formed by using recycled material or scraped material of the copper alloy of the present embodiment.

Preferably, the copper melt is a melt of so called 4NCu having a purity of 99.99% by mass or more. Preferably, the melting is performed by using a vacuum furnace or an atmospheric furnace while controlling the atmosphere to be inert gas atmosphere or reduced atmosphere so as to suppress oxidization of elements such as Mg and Al.

Next, an ingot is produced by pouring the copper alloy melt of controlled composition to a mold. Where the mass production effect is taken into consideration, it is preferable to use a continuous casting method or a semi-continuous casting method.

### Heating Step: 02

Next, a heating treatment is performed so as to homogenize and solid-solubilize the obtained ingot. The interior of the ingot includes intermetallic compounds or the like that are generated by enrichment of the added elements as a result of segregation of these elements during the solidification process of the alloy. Therefore, so as to eliminate or reduce the segregation and intermetallic compounds, the ingot is subjected to the heating treatment to heat the ingot to not lower than 500° C. and not higher than 1000° C., thereby diffusing the added elements homogeneously in the ingot and/or dissolving the added elements in the matrix phase. Preferably, the heating step S02 is performed under a non-oxidizing or reduced atmosphere.

### Quenching Step (Rapid Cooling Step): S03

Next, the ingot heated to not lower than 500° C. and not higher than 1000° C. in the heating step 02 is cooled to the temperature of not higher than 200° C. with a cooling rate of 200° C./min or more. Precipitation of intermetallic compounds including Mg and Al dissolved in the matrix phase is suppressed by this quenching step S03. As a result, an average number of intermetallic compounds having a particle diameter of 0.1 μm or more is controlled to be 10 μm² or less.

Hot working may be performed after the above-described heating step S02 and the above-described quenching step S03 may be performed after the hot working in order to make the rough processing efficient and to homogenize the microstructure. In this case, the working process is not particularly limited. For example, rolling may be applied where the final shape is a plate or a strip. Wire drawing, extrusion, groove rolling or the like may be applied where the final shape is a wire or a rod. Forging or pressing may be performed where the final shape is a bulk shape. After the quenching step 03, the heating step 02 and the quenching step 03 may be performed again for a purpose of, for example, performing the solution treatment (solid-solubilization) securely. That is, the heating step 02 and the quenching step 03 may be performed repeatedly for homogenization and solid-solubilization.

### Working Step: S04

The ingot after the heating step S02 and the quenching step S03 is cut where necessary, and is subjected to surface grinding where necessary in order to remove oxide film or the like generated during the heating step S02, quenching step S03 or the like. Then, the ingot is worked to the final shape.

The working process is not particularly limited. For example, rolling may be applied where the final shape is a plate or a strip. Wire drawing, extrusion, or groove rolling may be applied where the final shape is a wire or a rod. Forging or pressing may be performed where the final shape is a bulk shape.

Although the thermal conditions in the working step S04 is not particularly limited, it is preferable to control the temperature to be in a range of −200° C. to 200° C. such that the working is performed by cold working or warm working. The working ratio is selected discretionarily such that the shape of the alloy is made close to the final shape of the alloy. In order to improve the strength of the alloy by work hardening, it is preferable to control the working ratio to be 20% or more. In order to further enhance the strength, it is preferable to control the working ratio to be 30% or more.

The above-described heating step S02, the quenching step S03, and the working step S04 may be performed repeatedly. In this case, the second or following heating step S02 is performed with an intention of completing a solution treatment, recrystallizing the microstructure, or softening the alloy so as to improve the workability. The second or the following step is performed not on the ingot, but on the worked material.

### Heat Treatment Step: S05

Next, the worked material obtained by the working step S04 is subjected to heat treatment in order to perform low-temperature anneal hardening of the alloy or to remove residual strain. Conditions of the heat treatment step S05 is discretionarily determined in accordance with the properties that are desired in the produced product.

In the heat treatment step S05, it is necessary to control the heat treatment conditions (temperature, duration, cooling rate) such that intermetallic compounds of large size do not precipitate in large amount. For example, it is preferable to use heating for about 1 minute to 1 hour at 200° C., and for about 1 second to 1 minute at 300° C. Preferably, the cooling rate is controlled to be 200° C./min or more.

The method of the heat treatment is not particularly limited. It is preferable to perform heat treatment for 0.1 second to 24 hours at 100 to 500° C. under non-oxidizing or reducing atmosphere. The method of cooling is not particularly limited. It is preferable to use a method such as water-quenching such that the cooling rate is 200° C./min or more.

Further, the above-described working step S04 and the heat treatment step S05 may be performed repeatedly.

Thus, the copper alloy for an electronic device according to the present embodiment is produced. The copper alloy for an electronic device of the present embodiment is controlled to have a Young's modulus E of 125 GPa or less, and a yield strength σ_{0.2} at 0.2% of 400 MPa or more.

A copper alloy rolled material for an electronic device includes the above-described copper alloy for an electronic device according to the present embodiment and has a Young's modulus E of 125 GPa or less, and a yield strength σ_{0.2} at 0.2% in the rolling direction of 400 MPa or more.

The copper alloy tolled material for an electronic device is produced by performing rolling working step S04 of the above-described method of producing a copper alloy for an electronic device.

The copper alloy for an electronic device having the above-described constitution contains Mg in a range of 1.3 atomic % or more and less than 2.6 atomic % and Al in a range of 6.7 atomic % or more and 20 atomic % or less. The copper alloy of such a composition has a low Young's modulus, a high strength, and a relatively high electrical conductivity.

Specifically, the Young's modulus E is 125 GPa or less, the yield strength σ_{0.2} at 0.2% is 400 MPa or more. Therefore, the alloy has a high elastic energy coefficient (σ_{0.2}²/2E) and is not plastically deformed easily. Therefore, the alloy is specifically applicable to electronic/electric components such as terminals, connectors, relays or the like.

In the present embodiment, the alloy further contains one or more selected from Zn, Sn, Si, Mn, and Ni in an amount of 0.05 atomic % or more and 5 atomic % or less. In addition, the alloy contains one or more selected from B, P, Zr, Fe, Co, Cr, Ag, Ca, and rare earth elements in an amount of 0.01 atomic % or more and 1 atomic % or less.

The one or more elements selected from Zn, Sn, Si, Mn, and Ni and the one or more elements selected from B, P, Zr, Fe, Co, Cr, Ag, Ca, and rare earth elements have effects of improving properties of the copper alloy by being added to the copper alloy dissolving Mg and Al. Therefore, by adding these elements in accordance with the intended use, it is possible to provide a copper alloy of an electronic device and a copper alloy rolled material for an electronic device that are specifically appropriate for the intended use.

Further, in the copper alloy for an electronic device and the copper alloy rolled material for an electronic device of the present embodiment, the average number of the intermetallic compounds having a particle diameter of 0.1 μm or more is 10/μm² or less under the observation using a scanning electron microscope.

Since the average number of intermetallic compounds having a particle diameter of 0.1 μm or more is controlled to be in the above-described range, precipitation of coarse intermetallic compound is suppressed and at least partial fractions of Mg and Al are dissolved in the matrix phase. Therefore, it is possible to increase the strength and recrystallization temperature while maintaining high electrical conductivity and to reduce the Young's modulus. In addition, satisfactory bendability can be achieved.

The method of producing copper alloy for an electronic device according to the present embodiment includes heating step S02 to heat the ingot or the worked material of the above-described composition to the temperature of not lower than 500° C. and not higher than 1000° C. Therefore, Mg and Al can be dissolved by the heating step S02.

The method includes quenching step S03 to cool the ingot or the worked material that has been heated to not lower than 500° C. and not higher than 1000° C. by the above-described heating step S02 to 200° C. or lower with a cooling rate of 200° C./min or more. Therefore, it is possible to suppress precipitation of a large sized intermetallic compounds in a large amount during the cooling process.

Further, since the method includes working step S04 to work the quenched material, it is possible to improve the strength of the alloy by work hardening.

The heat treatment step S05 is performed after the working step S04 so as to perform low temperature anneal hardening or to remove residual strain. Therefore, it is possible to further improve the mechanical properties of the alloy.

As described above, according to the present embodiment, it is possible to provide a copper alloy for an electronic device and a copper alloy rolled material for an electronic device that have a low Young's modulus, a high yield strength, a high electrical conductivity, and excellent bendability, and that is appropriately applicable to electronic/electric components such as terminals, connectors, relays or the like.

While the copper alloy for an electronic device and the copper alloy rolled material for an electronic device according to the present embodiment are explained above, the present invention is not limited to the above-described embodiment. Modification can be made discretionarily in the range without departing from the claimed range.

For example, while an example of a method of producing copper alloy for an electronic device is explained in the above-described embodiment, the production method of the alloy is not limited to the present embodiment, and the alloy may be produced using a method selected from conventional production methods.

### EXAMPLE

In the following description, the results of affirmation experiments that were performed to affirm the effects of the present invention are explained.

A copper raw material composed of oxygen-free copper (ASTM B 152 C10100) having a purity of 99.99% by mass or more was prepared. Copper melts were obtained by installing the copper raw material in a crucible made of high purity graphite, and melting the copper raw material by high frequency melting in an atmospheric furnace under an Ar gas atmosphere. Various additive elements were added to each of the thus obtained copper melts, and the melts were made to have compositions shown in Tables 1 and 2, and ingots were produced by pouring each melt to a carbon mold. The ingot was controlled to have a thickness of ca. 20 mm, a width of ca. 20 mm, and a length of ca. 100 to 120 mm. The balance of each composition shown in Tables 1 and 2 is copper and unavoidable impurities.

As a homogenizing treatment, the obtained ingots were subjected to heat treatment under Ar gas atmosphere for 4 hours at 820° C., and subjected to water quenching.

Next, the ingots were subjected to hot rolling while controlling the maximum material temperature during the hot rolling to be in the range of 800 to 820° C., and were subsequently subjected to water quenching. Thus, hot rolled materials each having a thickness of 10 mm and a width of 20 mm were produced.

After that, as a solution treatment, each of the hot rolled materials was maintained at a temperature and time of heat treatment conditions described in Tables 1 and 2, and was subsequently subjected to water quenching.

Next, each of the rolled materials was cut while taking the final (target) thickness into account, and was subjected to surface grinding so as to remove the oxide film.

After that, cold rolling was performed under conditions shown in Tables 1 and 2, and strips having a thickness of ca. 0.5 mm and a width of ca. 20 mm were produced.

Finally, the obtained strips were maintained at 200° C. for 1 hour under Ar gas atmosphere, and were subsequently subjected to water quenching. Thus, strips for property evaluation were produced.

### Evaluation of Workability

Occurrence or absence of edge cracking (cracked edge) during the above-described cold rolling was observed in order to evaluate workability. The strips that did not show or scarcely showed edge cracking under visual observation were evaluated as “A (Excellent)”. The strips that showed occurrence of small edge cracking of less than 1 mm in length were evaluated as “B (Good)”. The strips that showed the occurrence of edge cracking of 1 mm or more and less than 3 mm in length were evaluated as “C (Fair)”. The strips that showed occurrence of large edge cracking of 3 mm or more in length were evaluated as “D(Bad)”. The strips that occurred fracture due to edge cracking during the rolling were evaluated as “E (Very Bad)”.

Here, the length of the edge cracking denotes the length of the edge cracking measured from the edge of the width of the rolled member towards the center of the width.

In addition, the electrical conductivity and the mechanical properties were measured using the strips for property evaluation.

### Electrical Conductivity

Test specimens of 10 mm in width and 60 mm in length were obtained from strips for property evaluation. The test specimen was obtained such that the longitudinal direction of each specimen was in parallel to the rolling direction of the strip for property evaluation.

Electric resistance of each specimen was measured using a four-terminal method. The volume of each specimen was calculated from measurement of the dimensions of the specimen using a micrometer. The electrical conductivity was calculated from the measured electric resistance and the volume.

### Mechanical Property

13B test pieces standardized in JIS Z 2201 were obtained from the strips for property evaluation. Each of the test pieces was obtained such that direction of tension during the tensile strength test was parallel to the rolling direction of the strips for property evaluation.

The test pieces were subjected to measurement of yield strength σ_{0.2} at 0.2% by the off-set method in accordance with JIS Z 2241.

Strain gauge was attached to each of the above-described test pieces and load and elongation were measured. The Young's modulus E was determined from inclination of stress-strain curve obtained from these data.

### Observation of Microstructure

With respect to Inventive Examples 1 to 18 and Comparative Examples 1 and 2, observation of microstructure was performed in the following way. Rolled surface of each sample was subjected to mirror-polishing and ion-etching. In order to examine the precipitation state of intermetallic compounds, the surface was observed using a field emission type scanning electron microscope (FE-SEM) at a 10000 fold magnification (ca. 120 μm²/area).

Next, in order to examine the density (number/μm²) of the intermetallic compounds, a visual field at a 10000 fold magnification (ca. 120 μm²/field) was selected such that the field (area) did not show biased precipitation of the intermetallic compounds. In this field, photographs of 10 continuous visual fields (ca. 4.8 μm²/field) were taken at a 50000 fold magnification.

The particle diameter of each intermetallic compound was achieved as an average value of the length of major axis and the length of the minor axis. The length of a major axis denotes the length of the longest straight line that can be drawn in the particle without having contact with a grain boundary in the intermediate position, and the length of a minor axis denotes the length of the longest straight line that can be drawn in the particle along the direction perpendicular to the major axis without having contact with a grain boundary in the intermediate position. Densities (number/μm²) of intermetallic compounds of 0.1 μm or more in particle diameter and densities (number/μm²) of intermetallic compounds of 0.05 μm or more in particle diameter were determined.

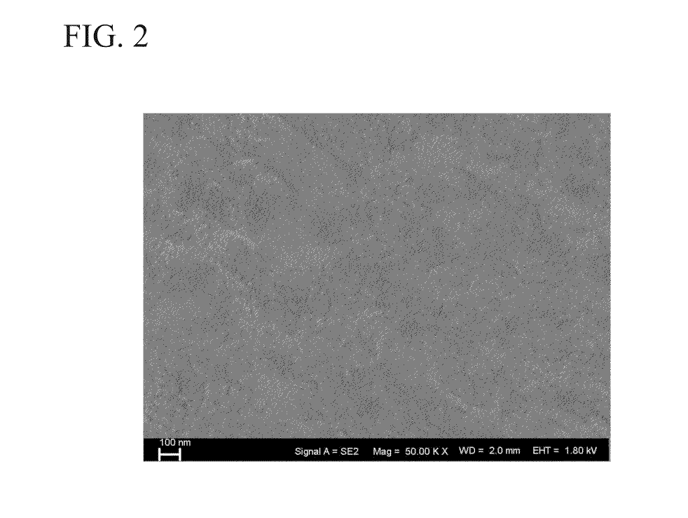

Production conditions and results of evaluation are shown in Tables 1 and 2. As examples of the above-described observation of microstructures, SEM observation photograph of the Inventive Example 6 is shown in FIG. 2.

TABLE 1

| | | | | | | | | | | | | | Microstructure | |
|---|---|---|---|---|---|---|---|---|---|---|---|---|---|---|
| | | | | Additional | | | | Working | | Electrical | Yield | | observation | |
| | | Mg | Al | element | | Heating treatment | | ratio in | Edge | conduc- | strength | Young's | (number/μm²) | |
| | | content | content | | content | conditions | | working | crack- | tivity | at 0.2% | modulus | 0.05 μm | 0.1 μm |
| | | (at. %) | (at. %) | Element | (at. %) | temperature | time | step | ing | (% IACS) | (MPa) | (GPa) | or more | or more |
| Inventive | 1 | 1.3 | 7.0 | — | | 720° C. | 4 h | 93% | A | 20% | 746 | 120 | 0 | 0 |
| Examples | 2 | 1.3 | 12.0 | — | | 720° C. | 4 h | 93% | B | 16% | 896 | 117 | 0 | 0 |
| | 3 | 1.4 | 15.0 | — | | 720° C. | 4 h | 93% | B | 15% | 992 | 115 | 0 | 0 |
| | 4 | 1.3 | 18.0 | — | | 600° C. | 24 h | 93% | B | 13% | 1076 | 111 | 0 | 0 |
| | 5 | 2.0 | 7.0 | — | | 720° C. | 4 h | 93% | A | 19% | 788 | 116 | 0 | 0 |
| | 6 | 2.0 | 12.0 | — | | 720° C. | 4 h | 93% | B | 15% | 938 | 109 | 0 | 0 |
| | 7 | 2.0 | 15.0 | — | | 720° C. | 4 h | 93% | B | 14% | 1028 | 106 | 0 | 0 |
| | 8 | 1.9 | 17.0 | — | | 600° C. | 24 h | 93% | B | 11% | 1082 | 102 | 0 | 0 |
| | 9 | 2.4 | 7.0 | — | | 720° C. | 4 h | 93% | A | 18% | 812 | 112 | 0 | 0 |
| | 10 | 2.5 | 12.0 | — | | 720° C. | 4 h | 93% | B | 14% | 968 | 110 | 0 | 0 |
| | 11 | 2.5 | 15.0 | — | | 720° C. | 4 h | 93% | B | 13% | 1058 | 108 | 0 | 0 |
| | 12 | 2.0 | 12.0 | — | | 720° C. | 4 h | 50% | B | 15% | 613 | 108 | 0 | 0 |
| | 13 | 2.0 | 12.0 | Zn | 0.1 | 720° C. | 4 h | 93% | B | 15% | 945 | 108 | 0 | 0 |
| | 14 | 2.0 | 12.0 | Zn | 2.0 | 720° C. | 4 h | 93% | B | 14% | 954 | 107 | 0 | 0 |
| | 15 | 2.1 | 12.0 | Sn | 0.1 | 720° C. | 4 h | 93% | B | 14% | 950 | 109 | 0 | 0 |
| | 16 | 2.0 | 12.0 | Si | 0.1 | 720° C. | 4 h | 93% | B | 14% | 941 | 109 | 0 | 0 |
| | 17 | 1.9 | 12.0 | Mn | 0.1 | 720° C. | 4 h | 93% | B | 14% | 940 | 108 | 0 | 0 |
| | 18 | 2.0 | 12.0 | Ni | 0.1 | 720° C. | 4 h | 93% | B | 15% | 945 | 109 | 0 | 0 |

TABLE 2

| | | | | | | Heating | | | | | | | Microstructure | |
|---|---|---|---|---|---|---|---|---|---|---|---|---|---|---|
| | | | | Additional | | treatment | | Working | | Electrical | Yield | | observation | |
| | | Mg | Al | element | | conditions | | ratio in | | conduc- | strength | Young's | (number/μm²) | |
| | | content | content | | content | tem- | | working | Edge | tivity | at 0.2% | modulus | 0.05 μm | 0.1 μm |
| | | (at. %) | (at. %) | Element | (at. %) | perature | time | step | cracking | (% IACS) | (MPa) | (GPa) | or more | or more |
| Inventive | 19 | 2.0 | 13.0 | B | 0.1 | 720° C. | 4 h | 93% | B | 14% | 968 | 110 | — | — |
| Example | 20 | 2.0 | 13.0 | P | 0.1 | 720° C. | 4 h | 93% | B | 13% | 949 | 111 | — | — |
| | 21 | 2.1 | 13.0 | Zr | 0.05 | 720° C. | 4 h | 93% | B | 14% | 963 | 110 | — | — |
| | 22 | 2.0 | 13.0 | Fe | 0.1 | 720° C. | 4 h | 93% | B | 13% | 950 | 109 | — | — |
| | 23 | 2.1 | 12.0 | Co | 0.1 | 720° C. | 4 h | 93% | B | 14% | 952 | 109 | — | — |
| | 24 | 2.0 | 12.0 | Cr | 0.1 | 720° C. | 4 h | 93% | B | 14% | 942 | 110 | — | — |
| | 25 | 1.9 | 12.0 | Ag | 0.1 | 720° C. | 4 h | 93% | B | 15% | 942 | 109 | — | — |
| | 26 | 2.0 | 12.0 | Ca | 0.1 | 720° C. | 4 h | 93% | B | 15% | 943 | 110 | — | — |
| | 27 | 2.0 | 12.0 | Ce | 0.1 | 720° C. | 4 h | 93% | B | 15% | 943 | 110 | — | — |
| | 28 | 2.0 | 12.0 | La | 0.1 | 720° C. | 4 h | 93% | B | 15% | 943 | 110 | — | — |

| | | | | | | | | | | | | | |
|---|---|---|---|---|---|---|---|---|---|---|---|---|---|
| Comparative | 1 | 1.0 | 0.0 | — | 720° C. | 4 h | 93% | A | 73% | 520 | 126 | 0 | 0 |
| | 2 | 1.0 | 0.0 | — | 720° C. | 4 h | 50% | A | 73% | 340 | 126 | 0 | 0 |

| | | | | | | | | |
|---|---|---|---|---|---|---|---|---|
| 3 | 2.0 | 23.0 | — | 600° C. | 24 h | 93% | E | Cracks occur during cold rolling |

| | | | | |
|---|---|---|---|---|
| 4 | 4.7 | 7.0 | — | Cracks occur during hot rolling |

Comparative Examples 1, 2 having a smaller Mg content and a smaller Al content than the ranges of the present invention showed a high Young's modulus of 126 GPa and 126 GPa and relatively low yield strength at 0.2% of 520 MPa and 340 MPa. Therefore, Comparative Examples 1 and 2 have low elastic energy coefficient (σ_{0.2}²/2E) and are plastically deformed easily. Therefore, it is concluded that Comparative Examples 1 and 2 are not suitable for electric/electronic components such as terminals, connectors, and relays or the like.

Comparative Example 3 having a larger Al content than the range of the present invention showed occurrence of large edge cracking in the time of cold rolling. As a result, it was impossible to examine their properties in the subsequent process.

Comparative Example 4 having a larger Mg content than the range of the present invention showed occurrence of large edge cracking in the time of hot rolling. As a result, it was impossible to examine their properties in the subsequent process.

On the other hand, each of Inventive Examples (Examples according to the present invention) 1-28 had low Young's modulus of 120 GPa or less and had yield strength at 0.2% of 600 MPa or more. Therefore, the Inventive Examples had high elastic energy coefficient (σ_{0.2}²/2E), and are excellent in elasticity. Therefore, they are suitable for electric/electronic components such as terminals, connectors, and relays or the like.

Where Inventive Examples 6 and 12 having the same composition and different working ratio are compared, it was confirmed that the yield strength at 0.2% can be improved by increasing the working ratio.

As explained above, it was confirmed that the Examples according to the present invention could provide a copper alloy for an electronic device that had a low Young's modulus, high yield strength, and high electrical conductivity, and that were suitable to electronic/electric components such as terminals, connectors, relays or the like.

### INDUSTRIAL APPLICABILITY

A copper alloy for an electronic device and a copper alloy rolled material for an electronic device according to the embodiment of the present invention have low Young's modulus, high Yield strength, high electrical conductivity. Therefore, the copper alloy and the copper alloy rolled material are appropriately applicable to electronic/electric components such as terminals, connectors, and relays or the like.

### EXPLANATION OF SYMBOLS

S02 Heating step
S03 Quenching step
S04 Heating step

1. A copper alloy for an electric device containing Mg in a range of 1.3 atomic % or more and less than 2.6 atomic %, Al in a range of 6.7 atomic % or more and 20 atomic % or less, and the balance substantially consisting of Cu and unavoidable impurities.

2. The copper alloy for an electronic device according to the claim 1, further containing one or more selected from Zn, Sn, Si, Mn, and Ni in an amount of 0.05% atomic % or more and 5 atomic % or less.

3. The copper alloy for an electronic device according to claim 1, further containing one or more selected from B, P, Zr, Fe, Co, Cr, Ag, Ca, and rare earth elements in an amount of 0.01% atomic % or more and 1 atomic % or less.

4. The copper alloy for an electronic device according to claim 1, wherein yield strength σ_{0.2} at 0.2% is 400 MPa or more.

5. The copper alloy for an electronic device according to claim 1, wherein Young's modulus E is 125 GPa or less.

6. The copper alloy for an electronic device according to claim 1, wherein average number of intermetallic compounds having a particle diameter of 0.1 μm or more is 10/μm² or less under the observation using a scanning electron microscope

7. A method of producing a copper alloy for an electronic device according to claim 1, comprising:
performing heating of a copper material to a temperature of not lower than 500° C. and not higher than 1000° C.;
performing quenching to cool the heated copper material to 200° C. or lower with a cooling rate of 200° C./min or more; and
performing working of the cooled copper material,
wherein the copper material is composed of a copper alloy containing Mg in a range of 1.3 atomic % or more and less than 2.6 atomic %, Al in a range of 6.7 atomic % or more and 20 atomic % or less, and the balance being substantially consisting of Cu and unavoidable impurities.

8. The method of producing a copper alloy for an electronic device according to claim 7, wherein the copper alloy that composes the copper material further contains one or more selected from Zn, Sn, Si, Mn, and Ni in an amount of 0.05% atomic % or more and 5 atomic % or less.

9. The method of producing a copper alloy for an electronic device according to claim 7, wherein the copper alloy that composes the copper material further contains one or more selected from B, P, Zr, Fe, Co, Cr, Ag, Ca, and rare earth elements in an amount of 0.01% atomic % or more and 1 atomic % or less.

10. A copper alloy rolled material for an electronic device, comprising the copper alloy for an electronic device according to claim 1, wherein Young's modulus E in the rolling direction is 125 GPa or less and a yield strength σ_{0.2} at 0.2% in the rolling direction is 400 MPa or more.

11. The copper alloy rolled material for an electronic device according to claim 10 that is used as terminals, connectors, or relays.

12. The copper alloy for an electronic device according to claim 2, further containing one or more selected from B, P, Zr, Fe, Co, Cr, Ag, Ca, and rare earth elements in an amount of 0.01% atomic % or more and 1 atomic % or less.

13. The copper alloy for an electronic device according to claim 2, wherein yield strength σ_{0.2} at 0.2% is 400 MPa or more.

14. The copper alloy for an electronic device according to claim 2, wherein Young's modulus E is 125 GPa or less.

15. The copper alloy for an electronic device according to claim 2, wherein average number of intermetallic compounds having a particle diameter of 0.1 μm or more is 10/μm² or less under the observation using a scanning electron microscope

16. A method of producing a copper alloy for an electronic device according to claim 2, comprising:
performing heating of a copper material to a temperature of not lower than 500° C. and not higher than 1000° C.;
performing quenching to cool the heated copper material to 200° C. or lower with a cooling rate of 200° C./min or more; and
performing working of the cooled copper material,
wherein the copper material is composed of a copper alloy containing Mg in a range of 1.3 atomic % or more and less than 2.6 atomic %, Al in a range of 6.7 atomic % or more and 20 atomic % or less, and the balance being substantially consisting of Cu and unavoidable impurities.

17. The method of producing a copper alloy for an electronic device according to claim 16, wherein the copper alloy that composes the copper material further contains one or more selected from Zn, Sn, Si, Mn, and Ni in an amount of 0.05% atomic % or more and 5 atomic % or less.

18. The method of producing a copper alloy for an electronic device according to claim 8, wherein the copper alloy that composes the copper material further contains one or more selected from B, P, Zr, Fe, Co, Cr, Ag, Ca, and rare earth elements in an amount of 0.01% atomic % or more and 1 atomic % or less.

19. A copper alloy rolled material for an electronic device, comprising the copper alloy for an electronic device according to claim 2, wherein Young's modulus E in the rolling direction is 125 GPa or less and a yield strength σ_{0.2} at 0.2% in the rolling direction is 400 MPa or more.

20. The copper alloy rolled material for an electronic device according to claim 19 that is used as terminals, connectors, or relays.
